(19) United States
(12) Patent Application Publication
(10) Pub. No.: US 2024/0343135 A1
(43) Pub. Date: Oct. 17, 2024

(54) VEHICLE CHARGING PORT

(71) Applicant: TOYOTA JIDOSHA KABUSHIKI KAISHA, Aichi-ken (JP)

(72) Inventor: Hisato KAWAHARA, Aichi-ken (JP)

(21) Appl. No.: 18/631,050

(22) Filed: Apr. 10, 2024

(30) Foreign Application Priority Data
Apr. 17, 2023 (JP) 2023-067268

(51) Int. Cl. B60L 53/16

(52) U.S. Cl. CPC B60L 53/16

(57) ABSTRACT

The vehicle charging port of the present disclosure includes an opening formed in a body, a charging inlet having a recess into which a charging connector is inserted, and a lid for opening and closing the recess and the opening. The vehicle switching port comprises a water-stopping member inserted into the recess along the inner surface of the recess when the opening is closed, wherein the water-stopping member is movable in a direction orthogonal to the direction of insertion into the recess.

This application claims priority to Japanese Patent Application No. 2023-67268 filed on Apr. 17, 2023, which is incorporated herein by reference in its entirety including the specification, claims, drawings, and abstract.

### TECHNICAL FIELD

The present disclosure relates to a vehicle charging port into which a charging connector is inserted.

### BACKGROUND

A battery electric vehicle is used in which a battery is charged by an external charging device, and a motor is driven by electric power supplied from the battery to travel. A charging port into which a charging connector is inserted is provided in such a battery electric vehicle. The charging port includes a lid provided in the body and a charging inlet attached to an opening in the lid. When the charging connector is inserted into the charging inlet, the battery is charged from an external charging device.

In the charging port having such a structure, water or sand may enter the inside of the charging inlet from the periphery of the lid provided in the body. Therefore, for example, WO2012/060009A1 discloses a structure in which an inner lid is provided in an opening portion of a charging inlet. The inner lid prevents water or sand from entering the interior of the charging inlet.

### SUMMARY

In order to prevent water or sand from entering the inside of the inner lid, a rubber seal lip is provided around the inner lid, and the lid and the inner lid are integrally opened and closed. In this case, there is a problem that the opening/closing load of the lid becomes large.

Accordingly, it is an object of the present disclosure to reduce the opening/closing load of the lid and to suppress the application of water to the terminal of the charging inlet.

The vehicle charging port of the present disclosure including an opening formed in the body, a charging inlet mounted inside the opening and having a recess into which a charging connector is inserted, a lid that opens and closes the opening and the recess of the charging inlet, a water-stopping member attached to the lid, wherein the water-stopping member is inserted into the recess along an inner surface of the recess of the charging inlet when the opening is closed, and the water-stopping member is attached to the lid so as to be movable in a direction orthogonal to a direction of insertion into the recess.

Since the water-stopping member is inserted along the inner circumferential surface of the concave portion of the charging inlet, water can be prevented from being applied to the center of the concave portion where the connection terminal is provided while reducing the opening/closing load of the lid. Further, according to the vehicle charging port of the present disclosure, even when there is a positional shift between the charging inlet and the water-stopping member, the water-stopping member can be easily inserted into the recess along the inner surface of the charging inlet.

In the vehicle cutting port of the present disclosure, the water-stopping member may include a tapered surface on an outer circumferential surface of a distal end portion, the tapered surface inclined such that an outer dimension thereof becomes smaller toward a distal end.

Thus, even when there is a positional shift between the charging inlet and the water-stopping member, the water-stopping member can be easily inserted into the concave portion along the inner surface of the charging inlet.

In the vehicle cutting port of the present disclosure, the charging inlet may include a connection terminal set including a plurality of connection terminals protruding from a bottom surface of the recess, and with the water-stopping member inserted into the recess, a tip of the water-stopping member extends further toward the bottom surface beyond a plurality of top surfaces of the plurality of the connection terminals, and a tip portion of the water-stopping member and a tip portion of each of the connection terminals overlap each other.

Thus, it is possible to reliably suppress water from being applied to the center of the concave portion where the connection terminal is provided

According to the present disclosure, it is possible to reduce the opening/closing load of the lid and suppress water hanging on the terminal of the charging inlet.

### BRIEF DESCRIPTION OF DRAWINGS

FIG. 1 is a side view of a vehicle to which a vehicle handling port according to an embodiment is attached;

FIG. 2 is an A-A cross-sectional view of the vehicle switching port shown in FIG. 1.

FIG. 3 is an elevation view showing a state in which a lid of the vehicle charging port shown in FIG. 1 is detached, showing a connection terminal of a charging connector and a recess portion into which the charging connector is inserted;

FIG. 4 is a plan view of the water-stopping member shown in FIG. 2, showing a state in which the water-stopping member is inserted into the charging connector.

FIG. 5 is a cross-sectional view showing a state in which the water-stopping member is inserted along the inner surface of the charging inlet when the lid is closed, taken along the line A-A of the vehicle charging port shown in FIG. 1.

### DESCRIPTION OF EMBODIMENTS

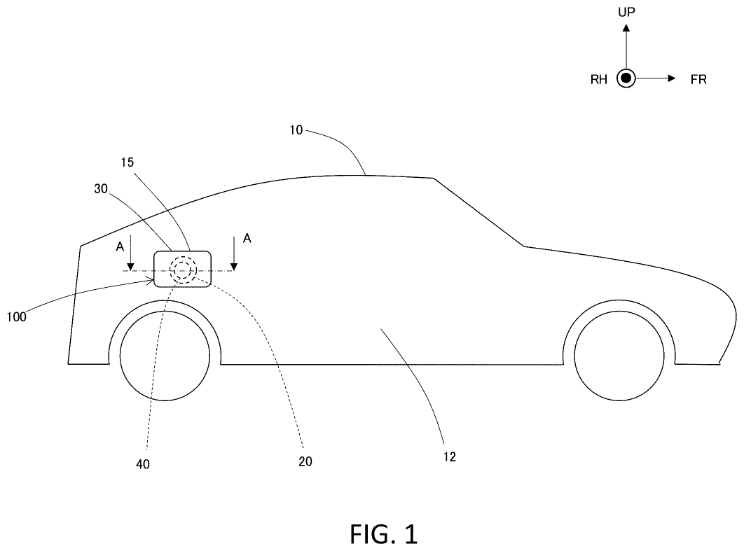

Hereinafter, a vehicle charging port 100 according to an embodiment of the present disclosure will be described with reference to the drawings. As shown in FIG. 1, the vehicle charging port 100 includes a charging inlet 20, a lid 30, and a water-stopping member 40. Arrows FR, UP, and RH shown in the drawings indicate the front side, the upper side, and the right side of the vehicle 10, respectively. The opposite directions of the arrows FR, UP, and RH indicate the rear side, the lower side, and the left side. Hereinafter, in the case of simply using the front-rear direction, the left-right direction, and the up-down direction, unless otherwise specified, the front-rear direction, the left-right direction, and the up-down direction of the vehicle 10 are indicated.

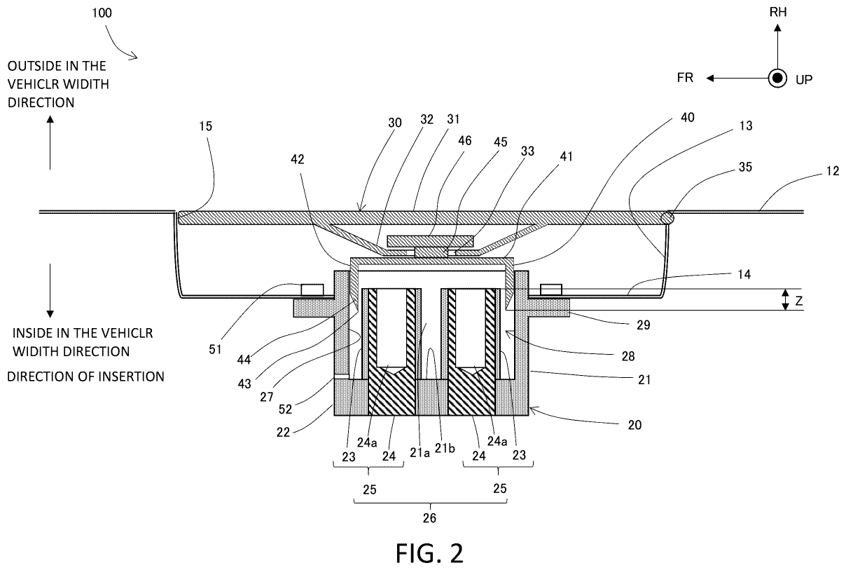

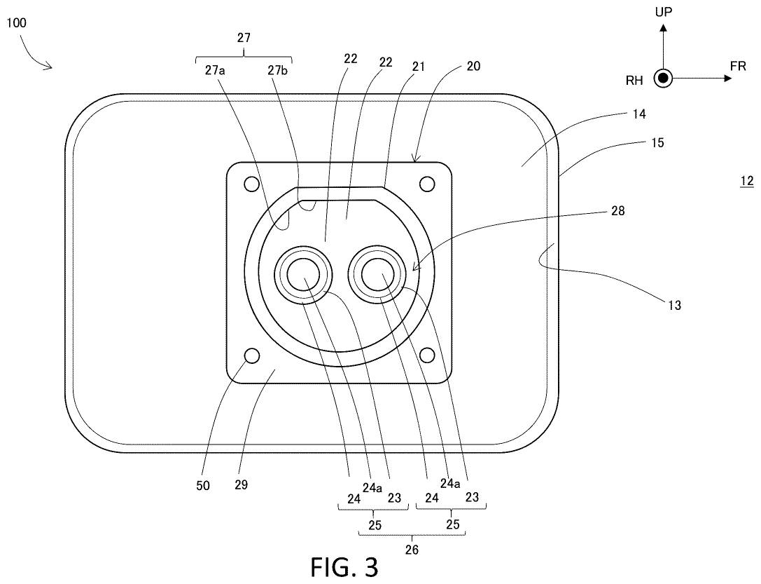

As shown in FIGS. 1 and 2, an opening 15 is formed in the body 12 of the vehicle 10. Inside the opening 15, a charging inlet mounting portion 13 recessed inward in the vehicle width direction is formed. The charging inlet 20 is fixed to the bottom plate 14 of the charging inlet mounting portion 13 by bolts 51. As shown in FIGS. 2 and 3, the charging inlet 20 includes a main body 21 and two connection terminals 25.

As shown in FIGS. 2 and 3, the main body 21 is made of resin, and includes an annular portion 27, a bottom plate 22, and a flange portion 29 protruding outward from the annular portion 27. The annular portion 27 includes a C-shaped partial cylindrical portion 27a and a flat plate portion 27b. The annular portion 27 is open toward the outside in the vehicle width direction. The bottom plate 22 is connected to the inner side of the annular portion 27 in the vehicle width direction. The inner surface of the annular portion 27 and the upper surface of the bottom plate 22 form a recess portion 21a of the main body 21. The upper surface of the bottom plate 22 constitutes a bottom surface 21b of the recess portion 21a. A charging connector (not shown) is inserted into the recess portion 21a.

Two connection terminals 25 are provided on the bottom surface 21b of the recess portion 21a. The connection terminal 25 includes a sleeve 23 and a female terminal 24. The sleeve 23 is a cylindrical member made of resin and protruding outward in the vehicle width direction from the bottom surface 21b of the recess portion 21a. The female terminal 24 is a metal terminal fitted to the inner surface of the sleeve 23. The female terminal 24 is provided at the center with a male terminal receiving hole 24a into which a male terminal (not shown) provided in a charging connector (not shown) is inserted. As shown in FIG. 2, the two connection terminals 25 are arranged side by side in the recess portion 21a of the main body 21. There is a gap 28 between each connection terminal 25 and the inner surface of the annular portion 27. The two connection terminals 25 constitute one connection terminal set 26.

Bolt holes 50 are formed in the flange portion 29 of the main body 21. The charging inlet 20 is fixed to the bottom plate 14 of the charging inlet mounting portion 13 by a bolt 51 inserted through the bolt hole 50. The annular portion 27 is provided with a drain hole 52 for draining the water entering the recess portion 21a to the outside.

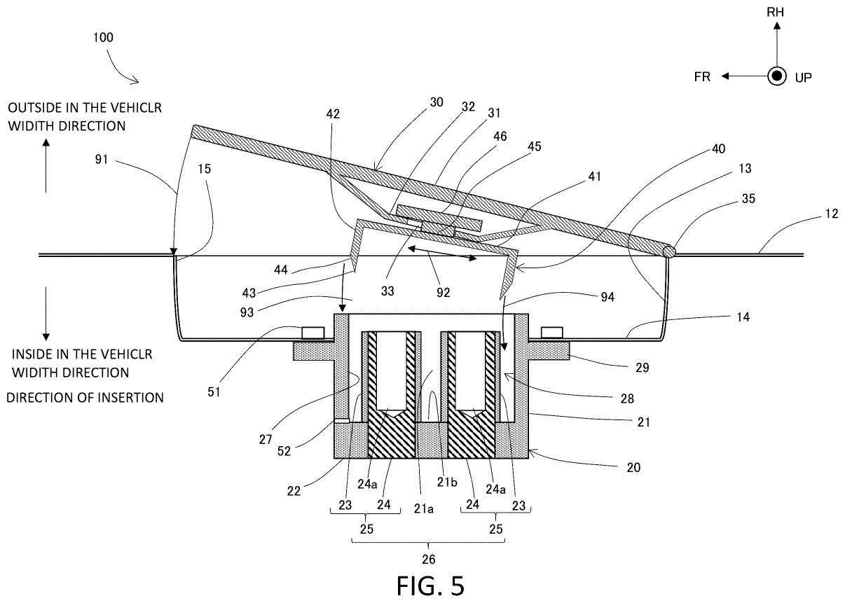

The lid 30 is a member for opening and closing an opening 15 formed in the body 12 of the vehicle 10. The lid 30 includes a main body 31, a bracket 32, and a hinge 35. The main body 31 is a plate member rotatably attached to the body 12 by a hinge 35. As shown in FIG. 5, the main body 31 rotates around the hinge 35 to open and close the opening 15. The bracket 32 is a folded plate member attached to the inner surface of the main body 31 in the vehicle width direction. The bracket 32 is provided with a mounting hole 33 for mounting a water-stopping member 40, which will be described later.

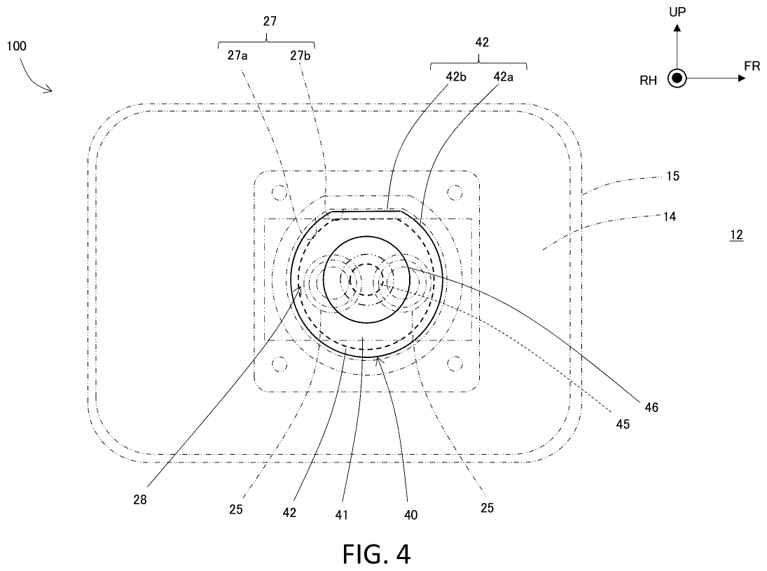

The water-stopping member 40 includes an upper lid 41, a insertion portion 42, a boss 45, and a lock member 46. As shown in FIGS. 2 and 4, the upper lid 41 is a disk with a chipped upper portion. The insertion portion 42 is an annular member extending from the upper lid 41 toward the bottom surface 21b along the inner side surface of the recess portion 21a of the charging inlet 20. Similarly to the annular portion 27 of the charging inlet 20, the insertion portion 42 includes a C-shaped partial cylindrical portion 42a and a flat plate portion 42b. The outer surface of the partial cylindrical portion 42a has a shape along the inner surface of the partial cylindrical portion 27a. The outer surface of the flat plate portion 42b has a shape along the inner surface of the flat plate portion 27b. As shown in FIG. 2, when the insertion portion 42 is inserted into the recess portion 21a, the distal end 43 of the insertion portion 42 extends toward the bottom surface 21b by a length Z from the distal end surface of each of the connection terminals 25 on the outer side in the vehicle width direction. Thus, when the insertion portion 42 is inserted into the recess portion 21a, the distal end portion of the insertion portion 42 and the distal end portion of each connection terminal 25 overlap each other by the length Z in the insertion direction. On the outer peripheral surface of the distal end portion of the insertion portion 42, a tapered surface 44 is provided which is inclined such that the outer dimension thereof becomes smaller toward the inner side in the vehicle width direction

The boss 45 is a protrusion which is provided at the center of the upper surface of the upper lid 41 and fits into the mounting hole 33 of the bracket 32. The outer diameter of the boss 45 is smaller than the inner diameter of the mounting hole 33. The height of the boss 45 is greater than the thickness of the bracket 32. A lock member 46 is attached to the upper end of the boss 45. The size of the lock member 46 is larger than that of the mounting hole 33. Accordingly, the water-stopping member 40 is attached to the bracket 32 so as to sandwich the bracket 32 between the upper lid 41 and the lock member 46 and to be movable in a direction orthogonal to the insertion direction.

Next, the opening and closing operation of the lid 30 will be described with reference to FIG. 5. As shown in FIG. 5, the lid 30 rotates around the hinge 35 to open and close the opening 15. When the lid 30 is rotated around the hinge 35 to close the opening 15 as shown by an arrow 91 in FIG. 5, the distal end 43 of the insertion portion 42 moves toward the recess portion 21a of the charging inlet 20 as shown by arrows 93 and 94 in FIG. 5. When the tapered surface 44 comes into contact with the inner surface of the recess portion 21a, the water-stopping member 40 moves in a direction orthogonal to the insertion direction with respect to the bracket 32, as indicated by an arrow 92 in FIG. 5. Thereby, the outer side surface of the insertion portion 42 is positioned along the inner side surface of the recess portion 21a. When the lid 30 is further closed, the insertion portion 42 is inserted into the recess portion 21a along the inner side surface of the recess portion 21a. At this time, the insertion portion 42 is inserted into the gap 28 between the inner side surface of the recess portion 21a and the outer side surface of the connection terminal set 26. When the lid 30 closes the opening 15, as shown in FIG. 2, the distal end of the insertion portion 42 and the distal end of each connection terminal 25 overlap each other in the insertion direction by a length Z. The upper lid 41 covers the upper surfaces of the recess portion 21a and the connection terminals. When the lid 30 is closed, the lid 30 covers the recess portion 21a of the charging inlet 20.

Thus, when water enters the inside of the opening 15 from the outside, the water passes between the outer surface of the insertion portion 42 and the inner surface of the recess portion 21a and enters the recess portion 21a. Then, the water entering the recess portion 21a is discharged to the outside of the charging inlet 20 through the drain hole 52. Therefore, it is possible to suppress water entering the opening 15 from the outside from entering the inside of the connection terminal 25.

Further, since the outer side surface of the insertion portion 42 can be aligned with the inner side surface of the recess portion 21a by the tapered surface 44 of the distal end portion of the insertion portion 42, the lid 30 can be smoothly opened and closed even when the positions of the lid 30 and the charging inlet 20 vary.

1. A vehicle charging port comprising:
an opening formed in the body;
a charging inlet mounted inside the opening and having a recess into which a charging connector is inserted;
a lid that opens and closes the opening and the recess of the charging inlet.
a water-stopping member attached to the lid, wherein the water-stopping member is inserted into the recess along an inner surface of the recess of the charging inlet when the opening is closed;
the water-stopping member is attached to the lid so as to be movable in a direction orthogonal to a direction of insertion into the recess.

2. The vehicle charging port according to claim 1, wherein
the water-stopping member includes a tapered surface on an outer circumferential surface of a distal end portion, the tapered surface inclined such that an outer dimension thereof becomes smaller toward a distal end.

3. The vehicle charging port according to claim 1, wherein
the charging inlet includes a connection terminal set including a plurality of connection terminals protruding from a bottom surface of the recess, and
with the water-stopping member inserted into the recess, a tip of the water-stopping member extends further toward the bottom surface beyond a plurality of top surfaces of the plurality of the connection terminals, and a tip portion of the water-stopping member and a tip portion of each of the connection terminals overlap each other.

4. The vehicle charging port according to claim 2, wherein
the charging inlet includes a connection terminal set including a plurality of connection terminals protruding from a bottom surface of the recess, and
with the water-stopping member inserted into the recess, a tip of the water-stopping member extends further toward the bottom surface beyond a plurality of top surfaces of the plurality of the connection terminals, and a tip portion of the water-stopping member and a tip portion of each of the connection terminals overlap each other.
